(19) United States
(12) Patent Application Publication
(10) Pub. No.: US 2012/0066315 A1
(43) Pub. Date: Mar. 15, 2012

(54) VISUAL IDENTIFIERS AS LINKS TO ACCESS RESOURCES

(76) Inventor: Douglas Louis Tuman, Mineola, NY (US)

(21) Appl. No.: 12/882,170

(22) Filed: Sep. 14, 2010

(51) Int. Cl. G06F 21/00; G06F 15/16

(52) U.S. Cl. 709/206; 726/17

(57) ABSTRACT

According to various embodiments, a user may wear or otherwise display a visual identifier that servers as a link to a resource. In various embodiments, a visual identifier may include an image and a code. In various embodiments, a visual identifier may include an image, a code, and a color. In various embodiments, a visual identifier may include a code and a color. In various embodiments, a characteristic of the user in combination with elements of the visual identifier may serve as a link to a resource. In various embodiments, a visual identifier servers as a link to an online resource.

### BACKGROUND

Data, services, and other resources are generally identified with a resource identifier such as a uniform resource locator (URL). For example, resource identifiers are often used to indicate a network location of email messages, alerts, application programs, social-networking profile-pages and the like. A typical URL may include characters that are used in combination to indicate information such as a resource's network location, query strings, settings, and/or other data. URLs found in emails, web pages, digital text documents, and in other digital mediums, when viewed on an apparatus that is connected to the Internet are often in the form of hyperlinks that can be digitally clicked for the purpose of being automatically directed to a resource. The ability to click on digital URL hyperlinks displayed on computer screens has made navigation to resources through the Internet convenient. When a URL is not in the form of a hyperlink, for instance when it is printed on paper in the physical world, than it is not digitally “clickable” and thus navigating to the resource associated with the URL requires extra steps and can be inconvenient. Attempts have been made to overcome this inconvenience and to essentially turn printed URLs into hyperlinks. For example, barcodes and 2-D barcodes have been used in place of printed URLs, allowing a person to essentially link-to the resources associated with the barcodes by way of a computing device with software and a scanner that can read a barcode and then automatically navigate the Internet to the associated resource. For example, 2-D barcodes can be found in magazines allowing people to link to the resource associated with the barcode by snapping a picture of the barcode and scanning it with an application on a Smartphone. Another current solution for making it easier to navigate to a resource associated with a printed URL, involves using services like http://bit.ly/ that can shorten long URL strings to short alphanumeric codes.

Despite some benefits, the above solutions have shortcomings, including when attempts are made to associate resources with a person viewed in the physical world. Currently, if a URL were to be used to associate a person in the physical world with a resource, such as their blog page, the person would have to wear the URL as a physical label, perhaps printed on their clothing. Anyone attempting to access the blog page associated with the URL label would have to be able to properly read the URL and then enter it into a web browser. Even if the URL label is shortened by way of http://bit.ly/, for example to a five (5) digit alphanumeric code such as http://bit.ly/asad2, and printed in a large font on clothing, the code would likely still be difficult to correctly read, memorize, and enter in a browser, unless optimal viewing conditions exist. Wearing a URL as a printed label, even a short-one, would most likely appear odd looking, and thus it would likely be difficult to integrate printed URLs into socially acceptable and fashionable apparel and accessories. It would also likely be difficult to integrate barcodes fashionably into apparel and accessories, and barcodes present other problems too. Given current technology it may be difficult for a device to read a barcode or a 2-D barcode that is being worn by a person unless optimal conditions (i.e. proper lighting, short enough reading distance, clear reading view, proper amount of time to capture the bar code, and proper reading angle) present themselves. Additionally, a barcode would only be machine-readable and thus would require a bar code reading device to be carried.

### SUMMARY

Although the foregoing discussion has been directed almost exclusively to accessing and exchanging information via the Internet—the world-wide “network of networks”, those of ordinary skill in the art will understand that it applies equally well to other internets (e.g. local area networks, etc.), and that the ensuing description of the embodiments should be considered as being applicable to the most general set of applications. Various embodiments include methods and/or devices.

Various embodiments include methods and devices for using human-readable and machine-readable visual identifiers as links to access internet resources associated with the visual identifiers.

Various embodiments include methods and devices for accessing internet resources associated with visual identifiers where the visual identifiers employ the usage of images in combination with short alphanumeric-codes allowing for many combinations of visual identifiers per image used.

Various embodiments include methods and devices for accessing internet resources associated with visual identifiers where the visual identifiers employ the usage of colors as an active factor in addition to images and short alphanumeric-codes, allowing for more available combinations of visual identifiers per image.

Various embodiments include methods and devices for accessing internet resources associated with physical-world objects. Such physical world objects may include humans, in various embodiments.

Various embodiments include methods and devices for accessing internet resources associated with visual identifiers where the visual identifier combinations employ the usage of gender of the person ultimately associated with the visual identifier as an additional active factor, allowing for even more available combinations.

Various embodiments include methods and devices for accessing internet resources associated with a person in the physical world where visual identifiers are used to represent a URL.

Various embodiments include methods and devices for accessing internet resources associated with a person in the physical world where the visual identifiers are readable by humans.

Various embodiments include methods and devices for accessing internet resources associated with a person in the physical world where the visual identifiers are readable by humans and/or machines.

Various embodiments include methods and devices for accessing internet resources associated with a person in the physical world where the visual identifiers are readily identifiable by humans from a distance, in low light, and/or which are passing quickly.

Various embodiments include methods and devices for accessing internet resources associated with a person in the physical world where the visual identifiers are more readily identifiable by humans than printed URLs are.

Various embodiments include methods and devices for accessing internet resources associated with a person in the physical world where the visual identifiers are easier to remember than are most printed URLs, names, number and/or letter key codes, words or phrases, and the like.

Various embodiments include methods and devices for accessing internet resources associated with a person in the physical world where the visual identifiers can be worn by the person as a graphic design on apparel, on accessories, as a tattoo, or the like.

Various embodiments include methods and devices for accessing internet resources associated with a person in the physical world where the visual identifiers employ the use of images that are easily recognizable and remembered and which look fashionable, such as popular images, symbols, trademarks, and the like.

Various embodiments include methods and devices for accessing internet resources associated with a person in the physical world where the visual identifiers employ the use of images that allow for individual expressions of social, business or other interests to be reflected through the selection of the active images.

Various embodiments include methods and devices for accessing internet resources associated with a person in the physical world where the person can communicate and express themselves by way of the associated internet resources to the people who view the person's visual identifier in the physical world.

In accordance with various embodiments, the URL of each individual profile web page within a network of profile web pages is associated with a unique visual identifier.

The visual identifiers employ the usage of images in combination with 1-3 alphanumeric character codes, allowing for thousands of combinations of unique visual identifiers per image. Colors may be employed as an active factor in addition to images and short alphanumeric codes, allowing for more available combinations of visual identifiers per image. The gender of the person ultimately associated with visual identifier can also be employed as an active factor, allowing for even more combinations. Alphanumeric characters, colors, and images can be added to increase the available combinations. A database on a server maintains a directory of which profile web page URL is associated with which visual identifier, and which visual identifier combinations are available to be associated. A person can access and view the profile web page associated with a visual identifier by viewing the visual identifier; identifying the image, alphanumeric characters, and color that the visual identifier is comprised of; by searching the directory of visual identifiers from an Internet connected device; by entering or selecting some of or all of the indentifying characteristics of the visual identifier into the directory search fields; and by selecting the correct visual identifier search result or being automatically directed to the profile web page associated with the searched visual identifier. The visual identifiers can also be machine-read, for example through image recognition technology, allowing an Internet connected device that has scanned a visual identifier to instantly access the web page associated with the visual identifier. Hyperlinks to numerous Internet resources can be posted on the profile web pages associated with the visual identifiers, thus effectively each visual identifier acts as a link to access multiple Internet resources. Each visual identifier and its profile web page can be assigned to a person. It is conceived that the visual identifiers can be worn by the person as graphic-designs on clothing, on their accessories, as tattoos etc., allowing a person to effectively broadcast and advertise access to Internet resources associated with their visual identifier to the people who see the person's visual identifier.

Other features and advantages will occur to those skilled in the art from the following description of various embodiments, and from the claims.

### BRIEF DESCRIPTION OF THE DRAWINGS

FIG. 1 illustrates a system 100 according to some embodiments.

FIG. 2 illustrates a more detailed view of server 102, according to some embodiments.

FIG. 3 illustrates a more detailed view of a user device according to some embodiments.

FIG. 4 illustrates an exemplary layout of a portion of image database 224, according to some embodiments.

FIG. 5 illustrates an exemplary layout of a portion of code database 228, according to some embodiments.

FIG. 6 illustrates an exemplary layout of a portion of patch database 232, according to some embodiments.

FIG. 7 illustrates an exemplary layout of a portion of user database 236, according to some embodiments.

FIG. 8 illustrates an exemplary layout of a portion of marketer database 240, according to some embodiments.

FIG. 9 illustrates an exemplary process flow 900, according to some embodiments.

FIG. 10 illustrates an exemplary user interface 1000, according to some embodiments.

FIG. 11 illustrates an exemplary item of clothing 1100 that features a visual identifier.

### DETAILED DESCRIPTION

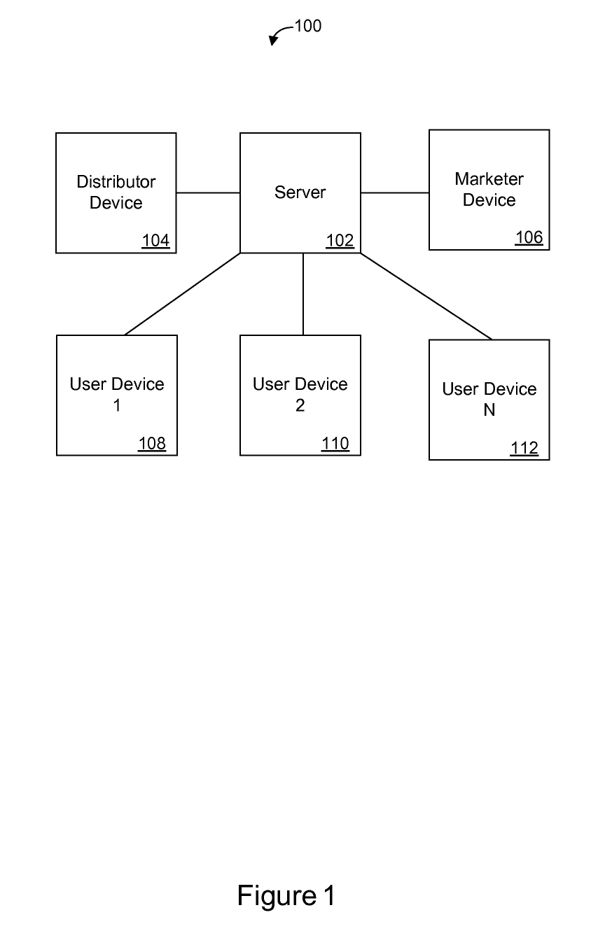

FIG. 1 illustrates a system 100 according to some embodiments. A system 100 according to various embodiments includes a server 102, distributor device 104, marketer device 106, and one or more user devices, e.g., user devices 108, 110, and 112. The devices may include one or more computing devices, such as servers, personal computers, portable computers, mobile phones, personal digital assistants, and so on. The devices may be in communication with one another. Communication may occur over a network, such as the Internet, the publicly switched telephone network, a local area network, a wide area network, or via any other network. The various devices of system 100 may be connected directly to one another, or may be connected via one or more intermediaries. Communication may occur using any applicable medium or technology, as may be appreciated, and may include copper wire, coaxial cable, Ethernet, fiber optic, Bluetooth, Wi-Fi, cellular communications, laser, infrared, and/or microwave. Communication may occur via any applicable protocol, including User Datagram Protocol (UDP), Internet Control Message Protocol (ICMP), Hypertext Transfer Protocol (HTTP), File Transfer Protocol (FTP), internet protocol (IP), transmission control protocol (TCP), Post Office Protocol (POP3), Simple Object Access Protocol (SOAP), and so on. Communication may or may not be continuous. Devices according to various embodiments may be in continuous, periodic, intermittent, sporadic, as-needed, and/or as available communication.

Devices according to various embodiments may include physical or virtual devices. For example, the server may be either a physical or virtual server, such as a virtual server instantiated using VMWare. In various embodiments, devices may include a single unified hardware apparatus, or multiple hardware apparatuses. For example, server 102 may be embodied as a single physical hardware apparatus or multiple physical hardware apparatus. In embodiments where a device comprises multiple separated physical components, such components may be spread out widely, e.g., thousands of miles away. For example, a server according to some embodiments takes the form of a “cloud” server, where various functions of the server may be distributed widely among physical servers. In some embodiments, a server may comprise separate functional units, such as processing and storage. Where a device comprises separated physical components, such components may be in communication with each other using any of the communication technologies, methodologies, modalities, etc., described herein.

The number of devices depicted in FIG. 1 represents but some embodiments, and it will be appreciated that more or less devices may be incorporated. For example, there may be more than three user devices, or fewer than three user devices. There may be more or fewer than one marketer device, and more or fewer than one distributor device.

It will be appreciated that, while FIG. 1 depicts various devices, some or all the functionality of some or all depicted devices may be carried out by humans, organizations, or other entities. For example, a human marketer may receive messages (e.g., audio messages) from the server device, without the intermediation of any marketer device.

According to some embodiments, a first user may access server 102 via a user device, such as user device 1 108. For example, the first user may use his personal computer to call up a Web page served by the server 102. The first user may provide personal information, obtain a visual identifier, and request an article of apparel incorporating the visual identifier. The server may then send instructions to the distributor device to provide the first user with the requested article of apparel with the visual identifier incorporated. The distributor may be a clothing manufacturer, for example. The server 102 may also report the request to the marketer device 106. For example, the visual identifier obtained by the first user may include a logo belonging to the marketer. As such, the server may inform the marketer that the marketer's logo has been obtained and/or is set to be incorporated into an article of apparel. The marketer may thereby be kept abreast of the use of its logo. In some embodiments, financial remuneration may also result from the use of the logo.

Sometime later, the first user may be outdoors wearing the article of apparel that incorporates the visual identifier. A second user may notice the first user and wish to get in touch with the first user. The second user may remember the visual identifier, which may include remembering a component picture and alphanumeric code, and a color of the visual identifier. The second user may then access the server via the user device 2, 110. The second user may enter into user device 2, from memory, information about the visual identifier. Receiving such information from user device 2, the server 102 may tie the information back to the first user. The server 102 may then transmit to user device 2 information about the first user, including some of the personal information previously provided by the first user to the server 102. For example, the server 102 may transmit to the second user profile information about the first user. The server may also provide a facility for the second user to send a message to the first user, such as an email, chat, or short message service (SMS) message. The server may also provide the second user access to web pages associated with the first user, such as the first user's Facebook™ profile page and the like. In this fashion, for example, the first user and the second user may become acquainted following a chance encounter.

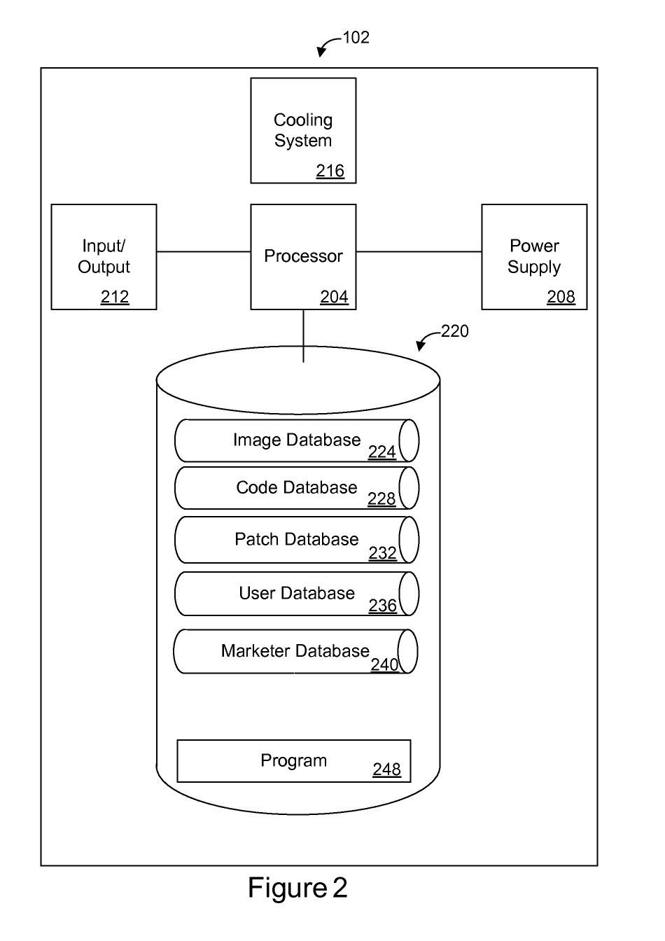

FIG. 2 illustrates a more detailed view of server 102, according to some embodiments. Server 102 may include such components as a processor 204, power supply 208, input/output terminal 212, cooling system 216, and storage device 220. Such components may include any applicable components from any applicable manufacturer. For example, processor 204 may include silicon-based processors, such an Intel® Xeon® processor, or an AMD™ Opteron™ processor.

Storage device 220 may employ any applicable storage technology, including hard disk, flash drive, magnetic tape, and so on. Storage device 220 may include memory or long term and/or short term storage, and may include random access memory, read-only memory, read-write memory, flash memory, electronically programmable read-only memory, and any other form of memory.

As will be appreciated, components of server 102 may be localized or distributed. For example, storage device 220 may comprise multiple physical devices that may be separated, or even widely separated. In some embodiments, certain components may be embodied as redundant pairs (or triplets, or quadruplets, etc.). For example, storage device 220 may comprise two disparate devices that are in separate cities, but that are periodically synchronized to serve as backup data repositories for one another. As will be appreciated, the server 102 itself, or any other device, may be embodied as redundant pairs, triplets, etc.

Server 102 may operate one or more software programs, packages, and/or modules. Such software may include an operating system (e.g., Windows™; e.g., Linux), database system (e.g., systems from Oracle™ or Microsoft™), virtualization software (e.g., VMWare™), server software, Web server software (e.g., Apache), software for serving emails (e.g., Zimbra), and any other software. Server 102 may operate one or more programs for operating in accordance with various embodiments. Software programs and/or data may be stored in storage device 220, e.g., as program 248. As will be appreciated, in various embodiments, one or more software programs, packages, or modules may be localized, or distributed.

Server 102 may store various data. Such data may enable the execution of various methods and processes described herein. Data may be stored in any suitable format. In some embodiments, data is stored in databases, such as relational databases or object relational databases. FIG. 2 depicts several databases according to some embodiments, including an image database 224, a code database 228, a patch database 232, a user database 236, and a marketer database 240. It will be appreciated that more or fewer databases could exist, in various embodiments. It will be appreciated that some of the depicted databases may be combined, or that some of the depicted databases may be divided into two or more databases, in various embodiments.

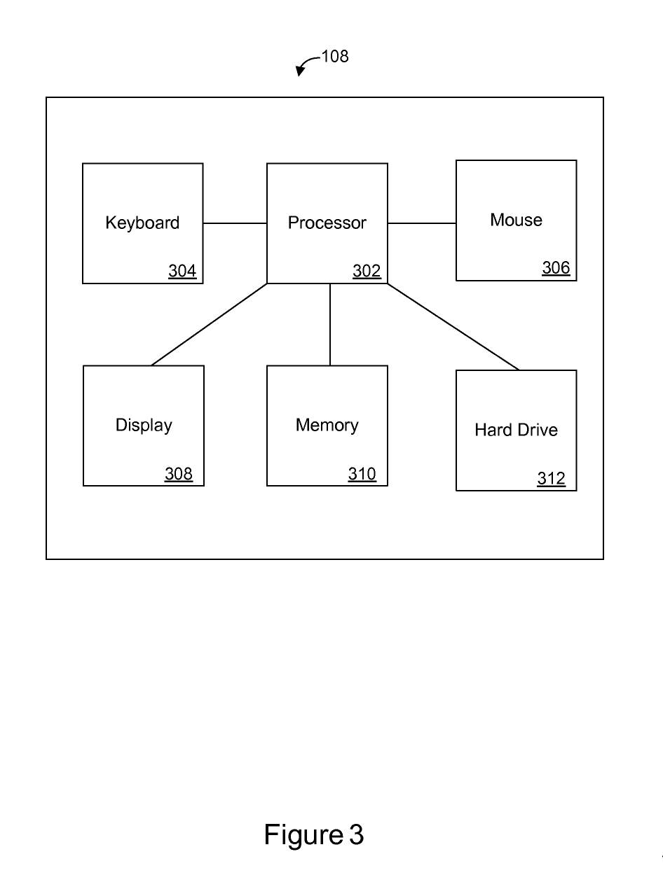

FIG. 3 illustrates a more detailed view of a user device (e.g., user device 1 108), according to some embodiments. A user device may be any standard or nonstandard computer, electronic, or other device, and may include a personal computer, mobile phone, laptop, gaming machine, kiosk, workstation, personal digital assistant, music player, movie player, or any other suitable device. FIG. 3 depicts components according to some embodiments, including processor 302, keyboard 304, mouse 306, display 308, memory 310, and hard drive 312. Components may include any standard or non-standard components, and may be obtained from any of a variety of manufacturers.

A processor may include, for example, an Intel® Celeron processor, an AMD™ Athlon™ processor, an ARM-based processor, or any other processor. A processor may include one or more components, as will be appreciated. For example, a processor may include a multi-purpose processor and/or a graphics processing unit (GPU).

Although FIG. 3 depicts a keyboard and mouse, it will be appreciated that various other input devices may be used. Other input devices may include joysticks, trackballs, cameras, touch pads, touch screens, microphones, motion detectors, gyroscopes, accelerometers, and any other input devices.

Display 308 may include any screen, monitor, or other output device. Display 308 may utilize such technologies as cathode ray tube (CRT), liquid crystal (i.e., LCD), light-emitting diode (LED), organic light-emitting diode (OLED), electronic paper (e.g., E Ink™), and so on. Display 308 may include a touch display 3D display, or any other type of display.

User device 1 may include memory 310, which may include various silicon or other types of memory, such as those described herein with respect to server 102. User device may further include hard drive 312, which may comprise various technologies and may come from various manufactures such as Fujitsu™, Hitachi™, Maxtor™, Seagate™, Western Digital™, etc.

It will be appreciated that various components described with respect to user device 1 108 may be singular, distributed, and/or virtual. Further, user device 1 108 may itself be embodied in a singular housing, or it may be distributed and/or virtual.

The marketer device 106 and the distributor device 104, may be similar to either or both the server 102 or the user device 1 108. For example, the marketer device 106 may be a personal computer or it may be a server.

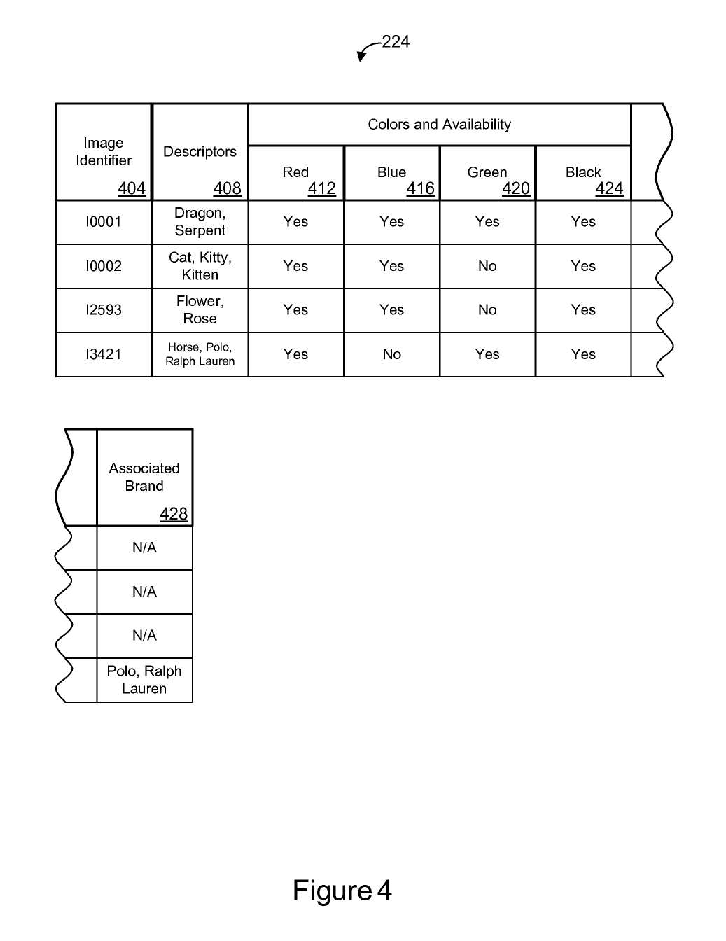

FIG. 4 illustrates an exemplary layout of a portion of image database 224, according to some embodiments. It will be appreciated that for this and for other databases described herein, the illustrated layouts represent layouts according to some embodiments, and that other layouts and arrangements are also contemplated according to various embodiments. Views depicted represent only portions of an entire database, in some embodiments, and it will be appreciated that other rows, other columns, other fields, and other data elements are contemplated. It should be understood that data depicted represents exemplary data, and is not intended to be limiting. Further, it will be appreciated that, in various embodiments, data need not be stored in the form of databases, but may be stored as flat files or in any other data structure, or in any other form. Additionally, it will be appreciated that certain data may be stored directly, or may be stored separately while the database itself contains links, references, or pointers to the data. For example, in some embodiments, a database does not directly store an image, but rather stores a pointer to the image.

Database 224 may store information about images that may be used in various embodiments. These images may include images that will or have been issued to users for the purpose of allowing the users to be identified out in public. An image identifier field 404 may store any suitable identifier, which may, in some embodiments, uniquely identify each image. Descriptors field 408 may store one or more possible image descriptors. Such descriptors may represent words that might describe or might be associated with the image. For example, an image that depicts a cat might have associated descriptors of “cat”, “kitten”, and “kitty”. It will be appreciated that any number of descriptors may be used. In some embodiments, when e.g., a second user is recollecting an image she has seen worn by a first user, the second user may enter a word or words describing the image she remembers. The server 102 may then consult database 224 to try to find such words in the descriptors field 408. Upon finding one of the words, the server 102 may present the associated image to the second user, e.g., by transmitting the image to user device 2 110. The second user may then have the opportunity to visually confirm whether or not the presented image was actually the image she had seen being worn by the first user.

Database 224 may store information about the colors in which a given image is available. For example, fields 412, 416, 420, and 424 may each represent different colors. For a given image, “yes” or “no” data may record whether or not an image is available in a particular color. For example, in some embodiments, an image used is a marketer's logo. Certain marketers may be sensitive as to the color in which their logo is depicted, and so may require that the image of their logo only be available in certain colors.

Field 428 of database 224 stores a brand associated with a particular image. For example, a particular image depicting a horse may be associated with the Polo™ brand of Ralph Lauren™. As will be appreciated, this or other fields could store information about an associated marketer, an associated manufacturer, or any other entity relating to a particular image.

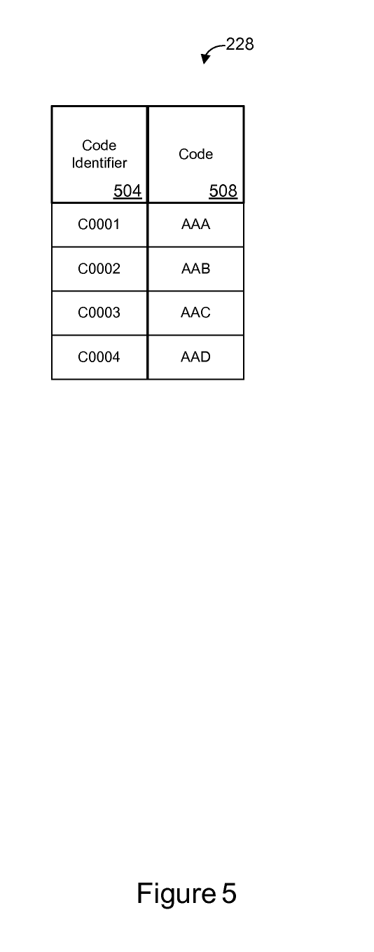

FIG. 5 illustrates an exemplary layout of a portion of code database 228, according to some embodiments. A code may include any sequence of characters, numbers, or other symbols. In various embodiments, a code may form part of a visual identifier (e.g., a “patch”) that may be worn or displayed by a user. In various embodiments, a code is comprised of a sequence of letters and numbers. In various embodiments, a code is comprised of a sequence of letters. In various embodiments, a code is comprised of a sequence of 3 letters. In various embodiments, a code is comprised of a sequence of two letters. In various embodiments, a code is comprised of a sequence of only one letter. In various embodiments, a code is comprised of a sequence of four letters. In various embodiments, a code is comprised of a sequence letters that represents the initials of the user that is wearing or otherwise displaying the code.

Code database 228 may store various codes 508 that are in use and/or usable. Each code may be associated with a code identifier 504, that may uniquely identify the code. In some embodiments, a code may serve as its own identifier. As will be appreciated, additional fields may be used in some embodiments. For example, an additional field may describe whether the code is available for use, is restricted, or is not available. For example, in some embodiments, certain codes representing words or brands (e.g., “IBM”) may be restricted from use.

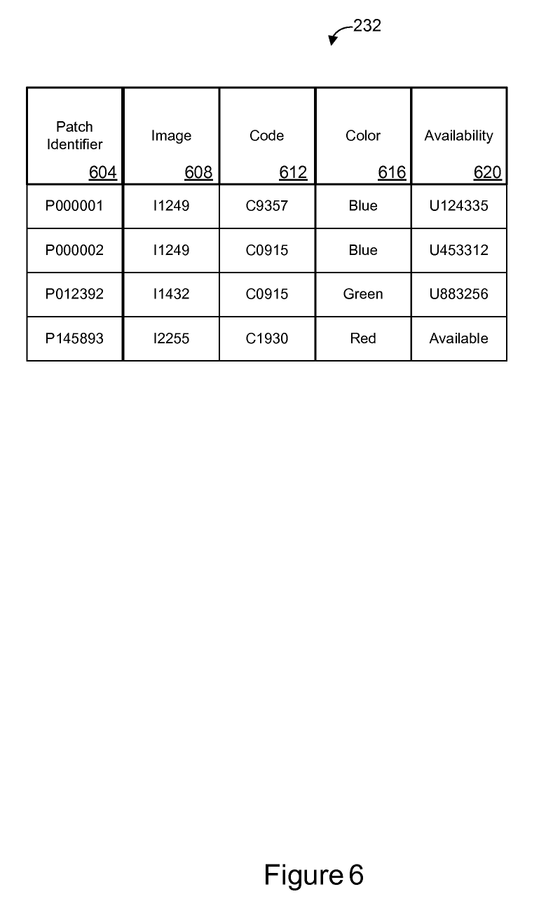

FIG. 6 illustrates an exemplary layout of a portion of patch database 232, according to some embodiments. A “patch” may include a visual identifier with the potential to be tied to or associated with a particular user and/or with information about the user. According to various embodiments, a second user who sees a patch worn or displayed by a first user will have the means to identify the first user or retrieve information about the first user using information from the patch as a key or link to the first user. In various embodiments, a patch may include or represent salient features (e.g., a small number of salient features) that can be tied to the wearer of the patch. In various embodiments, such features may include an object depicted (e.g., “bird”, “fish”, “flower”), a color (e.g., “red”, “pink”), and a code (e.g., “ACN”).

In various embodiments, a patch may have either or both of abstract and tangible instantiations. For example, a patch may exist as an abstract association of data, including image data, color data, and code data. However, a patch may also exist in tangible form, such as in the form of a picture or image printed on a shirt, or such as an image woven into a handbag. In various embodiments, the same patch may exist in multiple forms. In various embodiments, the same patch may exist in multiple forms, simultaneously. For example, a given user may have three shirts, each with the patch printed on it. That patch may also exist in the abstract, in the form of associated data stored on server 102 which ties the salient elements of the patch to the identity of the given user.

In various embodiments, a patch may be comprised of a combination of elements. These elements may include an image, a code, and a color.

Field 604 may include a patch identifier. The patch identifier may serve to uniquely identify a patch, in some embodiments. Field 608 may store the identifier for an image that forms part of the patch. Field 612 may store the identifier for a code that forms part of the patch. Field 616 may store the identifier for a color that is the color in which the associated image and/or code is to be rendered/displayed. Field 620 may store an indication of whether a patch is available. If a patch is not available, field 620 may indicate the user with whom the patch is associated. In various embodiments, in operation, a given user may request to obtain a patch. The server 102 may thereupon consult database 232 to see if the requested patch is available. If it is, then the server may assign the patch to the user, and change the associated record for that patch to reflect the new assignment. In various embodiments, in operation, the server may use database 232 to look up the identity of a user associated with a particular patch. For example, server 102 may receive an indication of an image, code, and color, and use database 232 to retrieve the identity of the user.

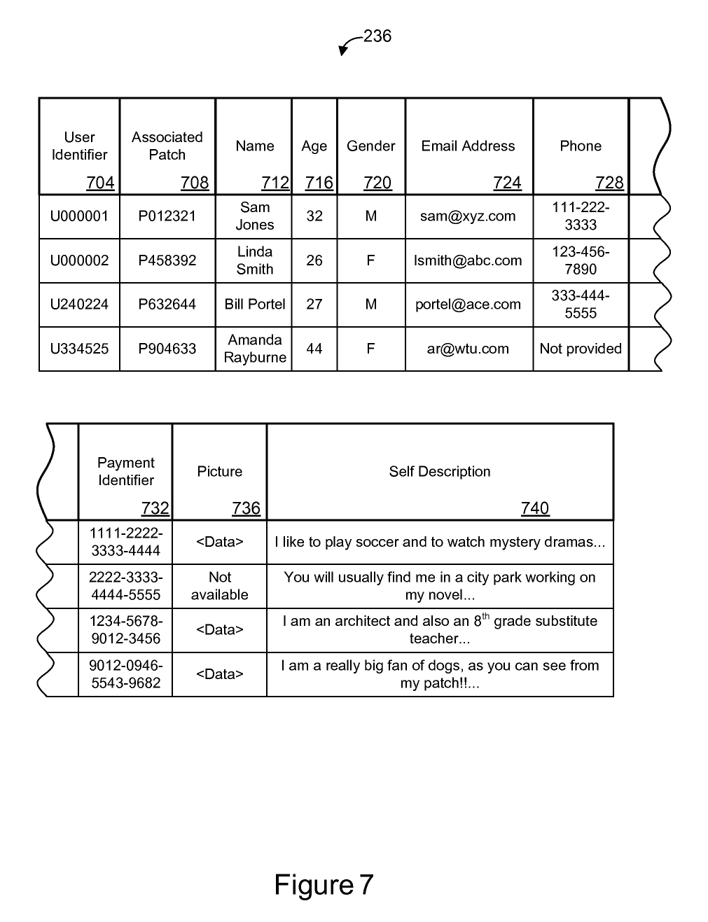

FIG. 7 illustrates an exemplary layout of a portion of user database 236, according to some embodiments. The user database may store information about various users associated with the server 102. Such users may include, for example, users who have signed up for a patch, users who have provided biographical information, users who have created a profile, users who have sought to contact other users, users who have purchased apparel, and/or any other users. Field 704 may store a user identifier, which may serve to uniquely identify a user, in some embodiments. Field 708 may store a patch identifier, which may indicate what patch is associated with a given user. Other fields may store biographical information, and may include name field 712, age field 716, and gender field 720. It will be appreciated that many other types of biographical information may be collected and/or stored, and that database 236 could be expanded accordingly. Other fields may include fields for contact information of a user, including e.g., email address field 724, and phone field 728. It will be appreciated that other types of contact information could be gathered, such as information about handles, aliases, postal address, fax numbers, personal website addresses, profile pages, etc., and that database 236 could be expanded accordingly.

Payment identifier field 732 may store payment information for a user, such as a credit or debit card number, check routing number, etc. Payment information may include a brand of credit card, expiration date, security code, or any other information that may be used in charging and/or in paying a user. Payment information may be used for various purposes, in various embodiments. For example, a user may be charged for apparel or accessories bearing a patch. A user may be charged to obtain a particular patch, such as a popular patch. A user may be charged a membership fee. A user may be charged for contacting another user, or for receiving messages from another user. In some embodiments, a user may be paid. For example, a user may be paid for wearing a patch that features the brand logo of a particular marketer.

Field 736 may include a picture of or relating to the user. For example, field 736 may store a portrait of the user that has been uploaded to server 102 by the user. Field 736 may, in some embodiments, store more than one image. Images stored in field 736 may be used in constructing, displaying, and/or presenting a profile or profile page for a user. It will be appreciated that field 736, or other fields, may similarly store video or audio files relating to a user.

Field 740 may include a “self description” of the user. The user may upload or enter this description. The self description may be stored for the purposes of generating, displaying, and/or presenting a profile of the user. It will be appreciated that various fields may be available for storing text or other information about the user. Such fields may be broken up into, e.g., “hobbies”, “profession”, “travels”, etc. Such fields may be used in a user profile, or such fields may be used for other purposes. For example, users may have the opportunity to search for other users based on what text the other users have included in their profiles.

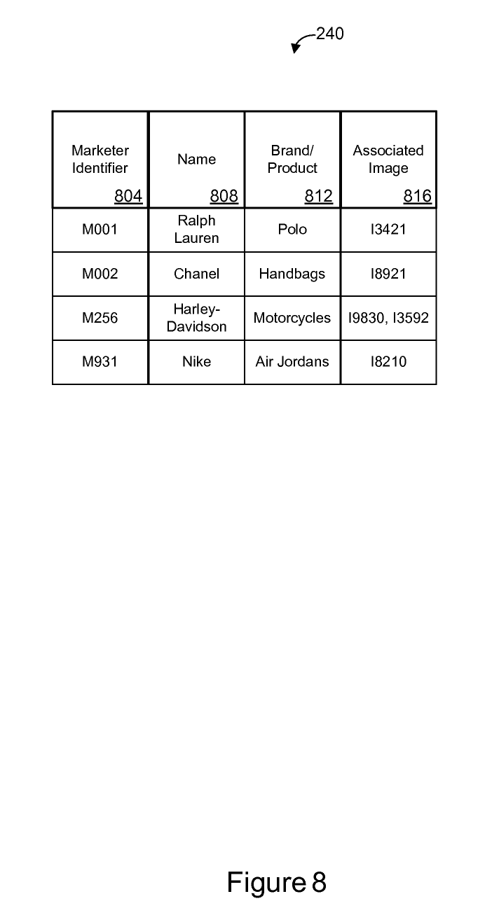

FIG. 8 illustrates an exemplary layout of a portion of marketer database 240, according to some embodiments. Marketer database 240 may store information about marketers that may be involved with the system 100. For example, marketers may include those that have supplied their logos or other brand identifiers to be used as patches. In various embodiments, marketers may include businesses, corporations, corporate divisions, brands, or other entities. In some embodiments, marketers may have a financial relationship or involvement with the present system 100 and/or server 102. For example, marketers may pay to have their logos incorporated into patches.

Field 804 may include a marketer identifier, which may serve to uniquely identify a given marketer. Name field 808 may store the name of a given marketer (e.g., Ralph Lauren™). Field 812 may store an indication of the brand or product being promoted by the marketer through system 100 (e.g., handbags). Field 816 may store an indication of an image or images that are used in patches and that are associated with the given marketer.

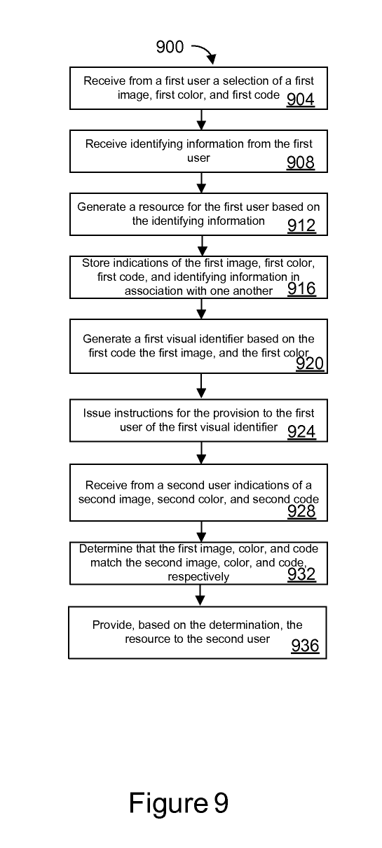

FIG. 9 illustrates an exemplary process flow 900, according to some embodiments. The process flow may be carried out by server 102, by server 102 in combination with another device or entity, and/or by another device or entity or combination of devices or entities. In various embodiments, the process flow depicted may be carried out with more or fewer steps, with a single step broken into multiple steps, with multiple steps combined, and/or with steps in an order other than that depicted. In some embodiments, various process steps may be carried out by a device other than the server 102, where such device is acting under programs, directions, and/or instructions provided by the server. For example, a user device may download a program from server 102 and execute one or more instructions of the program locally on the device.

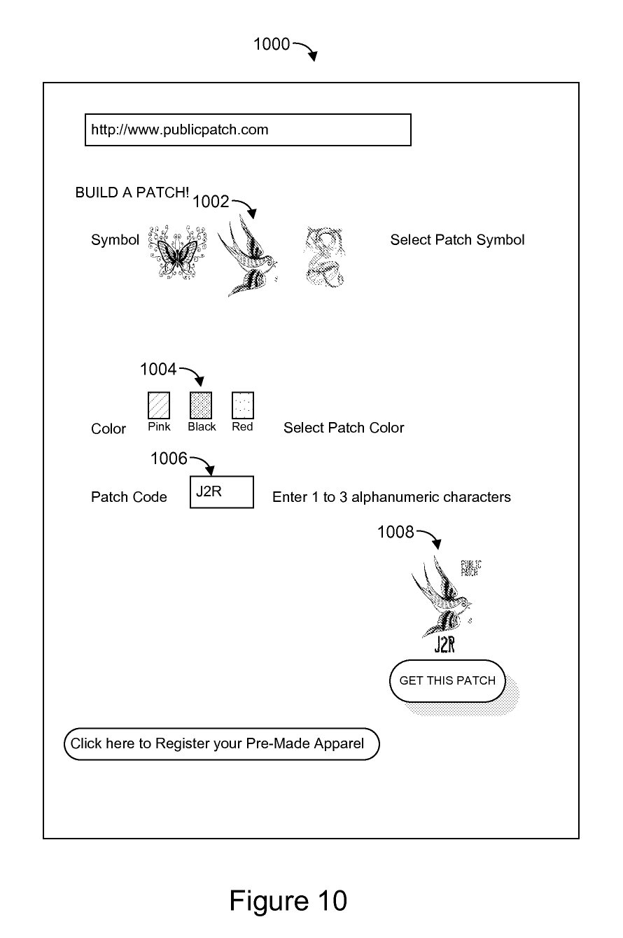

At step 904 server 102 receives from a user a selection of a first image, a first color, and a first code. The user may make his selections via a Web page associated with the server 102. An exemplary Web page 1000 is depicted in FIG. 10 according to some embodiments.

In some embodiments, the user may employ user device 1 108, or any other user device, and may use such device to access the Internet. The user may employ a browser, for example (e.g., Internet Explorer™ or Mozilla Firefox). The user may enter into the address bar of the browser a uniform resource locator (URL) address associated with the server 102. The server may thereby receive a request from the user device, and may transmit a Web page, Web pages, and/or Web application to the user device. In various embodiments, the user may be presented with an interface, such as a graphical user interface (GUI), through which to make his selections.

The user may be presented with one or more menus through which to make one or more selections. The user may be presented with one or more text boxes for making or entering selections in alphanumeric form. The user may be presented with check boxes or other means of selection, as will be appreciated. The selectors may allow the user to select an image, a color, and a code, according to some embodiments.

In some embodiments, the user is presented with one or more images. The images may be graphically depicted within a user interface presented to the user. The images may be full-size, reduced (e.g., in the form of thumbnails), or larger than normal size. The user may thereupon have the opportunity to select one of the images. For example, the user may use his mouse pointer and mouse to click on an image in order to select it. In some embodiments, the user may select an image from among descriptors of images rather than from the images themselves. For example, a user may select the word “bird” or “flower” in order to select an image of a bird or flower.

In some embodiments, the user is presented with one or more colors. The colors may be depicted as actual colors (e.g., as a red box to represent “red” or as a pink box to represent “pink”), or the colors may be represented by descriptors (e.g., “red”). The user may have the opportunity to select a color by, e.g., checking a box next to the desired color.

In some embodiments, the user is presented with one or more codes. Codes may include sequences of alphanumeric symbols. For example, a code may be “MHY”, or “JO2”. In some embodiments, letters used in codes are only those of the English alphabet. In some embodiments, a code may include letters from alphabets other than the English alphabet. The user may have the opportunity to select a code, e.g., by checking a box next to the code.

In some embodiments, the user may have the opportunity to enter a code using a keyboard or virtual keyboard. Using these or other means, the user may enter a single alphanumeric character at a time.

In some embodiments, server 102 (or a program transmitted by server 102) may suggest a code to the user. The suggested code may correspond to the user's initials, to an available code, or to a popular code, or the code may be suggested for some other reason or for no particular reason at all.

Once a user has selected, or been assigned an image, color, and code, a complete visual identifier may be presented to the user. The complete visual identifier may incorporate the image, color, and code. The user may then have the opportunity to confirm his selections or assignments. For example, the user can press a button saying, “Get this patch”.

In various embodiments, a user may select or may be assigned other elements, features, components, or portions of a visual identifier. For example, a user may select a pattern, shading, transparency level, or shadowing effect. In some embodiments, a user may select multiple images, each to form a portion of the ultimately assigned visual identifier. For example, a user may select a frog image and a stream image, and the ultimate visual identifier may show the frog by the stream. In some embodiments, a user may select an arrangement of elements. For example, the code may be above or below the image, or the code may be superimposed upon the image.

In various embodiments, the user does not select or is not assigned a color, image, and code. In some embodiments, the user is assigned only a color and image. In some embodiments, a user is assigned only a code and image. In some embodiments, a user is assigned only a color and code.

In some embodiments, some elements or components may be selectable by a user, while other components or elements may be assigned. In some embodiments, the user does not have the option to independently select elements. For example, the user may be required to select both an image and color together, or both a color and code together.

In some embodiments, a user is associated with a set of elements or components. When the user is associated, he may become so because he selected such elements or components, because such elements or components were assigned to him, or for some other reason. In some embodiments, a user is associated with a color, code, and image.

At step 908, identifying information is received from the user. Identifying information may include personal or biographical information. Identifying information may include a name, age, occupation, marital status, gender, height, eye color, weight, hair length, hair color, physical characteristic, presence of body art, build, complexion, skin tone, alma mater, or any other information. Identifying information may include contact information, such as an email address, screen name, alias, phone number, fax number, URL address, postal address, pager number, or any other address or any other contact information.

In various embodiments, a user may provide various information, whether or not it is used for identification purposes. A user may provide a picture, a video clip, information about the user's hobby, information about the user's jobs, identities or information about the user's friends, and so on.

In some embodiments, information may be received from a user so as to create or generate a publicly viewable profile for the user. Such information may be displayed as a Web page or a portion of a Web page, or more than one Web page, and may be available for viewing or downloading by other users.

Information provided by a user may be associated with an image, code, and color that has been associated with the user (e.g., that has been selected by the user). Information provided by a user may be associated with a visual identifier that has been assigned to or selected by the user. Information provided by the user may be associated with a user account, user login information, or other user identification information. In various embodiments, one or more items of user information may be associated with a visual identifier.

At step 912, a resource is generated for the first user based on the identifying information. In some embodiments, information provided by a user may constitute a resource. A resource may include a uniform resource locator, email address, other address, Web page, or any key, tie, or link to a store of data or to a service. A resource may include a store of data or a service. In some embodiments, a resource may be generated by the server 102 for the user. For example, the server 102 may generate a Web page for the user based on information provided by the user. The Web page may thus constitute a resource. In some embodiments, the server may generate a username, email address, screen name, or other means of contact for the user. These may also constitute resources, in some embodiments.

At step 916, indications of the first image, first color, first code, and indentifying information provided by the first user are stored in association with one another. Database 236, for example, stores identifying information of users in association with a patch identifier. The patch identifier may, in turn, be used to access image, code, and color information via database 232.

In some embodiments, a resource may be associated with elements or components chosen or assigned to the user. For example, a particular resource may be associated with a particular combination of image, color, and code. In this way, the particular combination of image, color, and code, may serve as a pointer to, or access point to the resource.

It will be appreciated that, in various embodiments, more or fewer elements or components (e.g., only an image and code) may be stored in association with identifying information.

It will be appreciated that storing items of information in association with one another may include storing items of information in such a way that one item of information can be used to retrieve another item of information, either directly or indirectly.

At step 920, a first visual identifier is generated based on the first code, the first image, and the first color. The visual identifier may include, incorporate, and/or feature each of the first code, the first image, and the first color. For example, with reference to FIG. 10, suppose the user has chosen bird image 1002, “black” color 1004, and code “J2R” at 1006. A composite image or visual identifier 1008 may thus be generated for the user incorporating the chosen bird image and the code J2R printed just underneath, all using the color black.

As will be appreciated, in various embodiments, a visual identifier may be generated in other ways. For example, the code may go above or to either side of the image. In some embodiments, the code may be woven into the image in some fashion.

In some embodiments, a visual identifier may include instructions for linking the visual identifier to the identity of the wearer. For example, a visual identifier may include printed instructions saying, “Remember this patch and log onto PublicPatch.com in order to contact the wearer.” In some embodiments, a visual identifier may contain simpler or abbreviated instructions. For example, the visual identifier may include just the words “Public Patch”, whereupon it would be understood that someone is to visit Website http://www.publicpatch.com in order to be able to contact the wearer. In some embodiments, the visual identifier may include a logo or other mark indicative of the means to link the visual identifier to the wearer.

At step 924, instructions may be issued for the provision to the first user of the first visual identifier. Providing the first user with the visual identifier may include sending the user clothing, apparel, accessories, printed matter, electronic displays or anything else that shows the visual identifier. In some embodiments, the visual identifier is emailed or otherwise electronically transmitted to the user. In some embodiments the user, or another entity, is provided with instructions for creating the visual identifier himself.

In various embodiments, the server may be associated (e.g., through a business relationship) with a distributor. The distributor may employ distributor device 104, which may be a computer, cell phone, or any other device. The distributor may be a clothing manufacturer, an augmenter of clothing, or a clothing printer, for example. The distributor, via distributor device 104, may receive instructions to send a shirt bearing the first visual identifier to the first user. Thus, the instructions may include an indication of the visual identifier, and an indication of the first user's address.

In some embodiments, a distributor may be a tattoo parlor or tattoo artist. The distributor may be issued instructions to provide to the user a tattoo of the first visual identifier.

In some embodiments, a distributor may use intermediaries in the process of delivering the visual identifier to the user. In some embodiments, the distributor itself may consist of more than one entity. In some embodiments, the distributor may be part of the same entity of which server 102 is a part. For example, the same company that generates visual identifiers may also print and distribute apparel containing the visual identifiers.

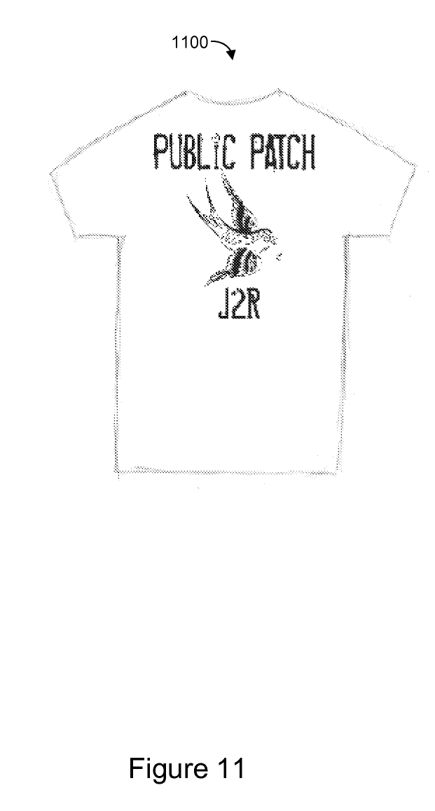

FIG. 11 illustrates an exemplary item of clothing 1100 that features a visual identifier. Once provided with the visual identifier (e.g., on an item of clothing), the first user may exhibit or display the visual identifier. For example, the first user may wear an article of clothing featuring the visual identifier.

A second user may see the visual identifier while worn or otherwise exhibited by the first user. The second user may wish to contact the first user. The user may then log onto the server 102, or otherwise come into contact with the server.

At step 928, indications of a second color, second image, and second code are received from a second user. For example, the second user may enter such information into a Web page of the server. The second user may enter such information by selecting from menus, from images, by using check boxes, by entering text, words, and/or letters, or through any other means, as will be appreciated.

If the second user has seen the visual identifier of the first user, and has remembered the visual identifier correctly, then presumably the second color, second image, and second code will turn out to be the same as the first color, first image, and first code (i.e., the color, image, and code initially issued to the first user).

At step 932, it is determined that the first color, first image, and first code match the second color, second image, and second code. In various embodiments, a match occurs when all element or components match exactly. In some embodiments, a match may occur even when less than all components match. For example, the second user may have remembered only the image and code, but forgotten the color. Nevertheless, the server 102 may be able to determine a match between the information entered by the second user, and the visual identifier of the first user (e.g., the first color, first image, and first code).

In some embodiments, if there is not a complete or fully accurate match, then the second user may be presented with images of other users, and/or with other information about other users (e.g., with information about physical characteristics about the other users). The second user may be asked if he/she can identify the first user from among the presented images of the other users.

In some embodiments, a match may be deemed to have occurred when each of a particular subset of components provided by the second user are identical to components associated with the first user. The subset need not be the full set of components provided by the second user, in some embodiments (e.g., at least one component provided by the second user may not be identical to a component associated with the first user). In some embodiments, a match may be deemed to have occurred when each of a particular subset of components associated with the first user are identical to components provided by the second user. In some embodiments, a match may occur when some or all components, though not identical, are “close”. For example, a second user may describe an image as a “reptile” when in fact it is a frog. A frog, though not a reptile, may be deemed close enough. As another example, a second user may describe a height characteristic of a first user as 6 feet, when in fact the first user is 5 foot 11 inches. Thus, as will be appreciated, matches may be deemed to have occurred based on a partial or near matching of components, characteristics, etc., in various embodiments.

At step 936, based on the determination that a match has been made, the second user may be presented with the resource generated for, or associated with, the first user. The resource may be an email address for the first user, for example. The second user may thus have the opportunity to contact the first user.

Thus, in various embodiments, a second user who wishes to contact a first user may do so having seen a visual identifier associated with, and exhibited by the first user. The visual identifier may comprise elements, features, or components that can be readily remembered, which may make it easier for the second user to contact the first without the need to immediately record information about the visual identifier.

### Some Embodiments

In various embodiments, more than one variation or rendition of an image can exist. For example, a patch with a tattoo style bird or a modern art rendition of a bird may both be considered to include the same image, and may thus be considered to be the same patch (e.g., if other aspects of the patch are the same as well, such as color, code, etc.). Thus, in various embodiments, different renditions of the same image may be identified in the same way when it comes to associating a patch with a user, resource, etc. Thus, in various embodiments, a user may own multiple BLACK DRAGON DT patches and the dragon on each one can be a different image.

In various embodiments, a user who obtains a visual identifier (e.g., a patch) must first “register” the visual identifier before the visual identifier will become associated with that user (or with information about the user). In some embodiments, a given visual identifier has an associated registration key. On a visual identifier incorporated into an article of clothing, for example, the registration key may be woven in small letters or otherwise incorporated into the visual identifier or into the article of clothing itself. When a user purchases an article of clothing, or otherwise obtains a visual identifier, the user may log onto server 102 and enter the registration key. The server may thereupon associate the visual identifier with the user. In some embodiments, the user need only enter the registration key, and need not enter some (or any) information about the visual identifier. In some embodiments, if a first user fails to “register” a visual identifier, but nevertheless wears it in public, then a second user who visits the server and enters details about the visual identifier will be unable to obtain any contact information about the first user. Thus, if the first user wishes to be contacted, the first user is encouraged to register the visual identifier. As will be appreciated, visual identifiers may be obtained through a purchase from the server 102, through a purchase from a third party working with the server (e.g., from a purchase from a distributor), or through any other means.

Though various embodiments have described that a visual identifier (e.g., combination of image, color and code) may serve as a key, link, pointer, or tie to a resource associated with a user, it will be appreciated that a visual identifier could just as well serve as a key, link, pointer, or tie to any other resource. Thus, in various embodiments, a person or other entity may access a resource by providing characteristics of the visual identifier. For example, a user may access a Web page by indicating a particular image, color, and code. As another example, a user may access a Web page by indicating a particular image and color. As another example, a user may access a Web page by indicating a particular image and code. In various embodiments, other combinations of components of a visual identifier may be used for accessing a resource.

In various embodiments, a visual identifier may serve as a link to a resource. The visual identifier may include salient features, characteristics, or descriptors, that are not represented as alphanumeric characters, yet nevertheless serve as a critical part of the link. Thus, for example, the color of the image may be a critical component of the link, even though the color is expressed or featured as is, without verbal description.

In some embodiments, features, characteristics, or descriptors of a visual identifier may be combined in order to arrive at a link to a resource. In some embodiments, features, characteristics, or descriptors, when expressed in alphanumeric form, may combine to form an alphanumeric string that is a link to a resource. The combination of features, characteristics, or descriptors expressed in such fashion may be augmented by additional alphanumeric characters. In some embodiments, features, characteristics, or descriptors are expressed in alphanumeric form and concatenated to form the first part of an email address (e.g., the part before the “@” symbol). The latter part of the email address (e.g., the part after the “@” symbol) may be formed out of other alphanumeric characters (e.g., a standard set of alphanumeric identifiers that is independent of any given visual identifier; e.g., a business name or domain name associated with server 102). For example, a visual identifier that includes the color black, a dragon image, and the code “DT” may represent an email address of a user (e.g. blackdragondt@publicpatch.com).

In various embodiments, a second user may view a visual identifier worn by a first user. The second user may then visit a Web site associated with the server 102. The second user may enter information about the visual identifier he has seen. Assuming the second user has entered the information correctly, the server 102 may then facilitate communication between the second user and the first user. For example, the server 102 may relay email messages back and forth between the first user and the second user. In some embodiments, the server 102 may facilitate chat between the first and second users (e.g., may facilitate Instant Messaging communications). In some embodiments, the server 102 may facilitate SMS messaging or any other form of communication between the first and second users.

In various embodiments, the server may provide, incorporate, or otherwise include links or references to external resources, such as external web pages, Facebook™ pages, Twitter™ accounts, profiles, and so on. For example, the server 102 may maintain a profile page associated with a user. The server may provide the user with the opportunity to list links to external resources on the profile page.

In some embodiments, a profile page associated with a user may indicate other places where the user can be found. Such places may include, for example, other Websites, video sharing sites, videos posted on the Web, images posted on the Web, photo sharing sites, and so on.

In various embodiments, a user may provide identifying characteristics, biographical information, or other information. Once certain information is provided, the server may prevent the user from changing this information. In some embodiments, once a user provides a gender, he cannot change his/her gender.

In various embodiments, identifying information of a first user servers as a characteristic or descriptor through which a second user will later find the first user. For example, a second user may log onto the server seeking to contact the first user. The second user may provide characteristics of a visual identifier worn by the first user (e.g., color, e.g., code), but may also provide characteristics of the user (e.g., gender). Thus, in some embodiments, a characteristic provided by a user may serve as a means to identify the user. In some embodiments, a characteristic provided by a user may serve as a means to uniquely identify the user. If a user is prevented from altering information that serve as a means to uniquely identify the user, then situations may be avoided where one user changes information and thereby arrives at a set of identifying characteristics that is the same as those of another user.

For example, both a male and female may be assigned the exact same visual identifier. However, each can still be uniquely identified using their gender in combination with characteristics of the visual identifier. However, were the “male” hypothetically allowed to alter his gender information to “female”, then the characteristics associated with the “male” would no longer be unique.

Thus, in various embodiments, a user is not permitted to alter information that serves as a means (e.g., in combination with the visual identifier) by which other users would identify the user.

In various embodiments, a visual identifier may include a brand, logo, trademark, or other mark associated with the server 102 or the company owning the server. For example, a visual identifier may include the words “Public Patch”.

In some embodiments, a visual identifier may include a brand, logo, image, or other mark that is associated with a charity. For example, a user may wish to wear a visual identifier that signifies his support for the charity. In some embodiments, an image may be associated with a non-profit organization, a foundation, or with any other organization or cause. In some embodiments, a user may identify a charity. When a user purchases apparel, some part of the purchase price may go to that charity. In some embodiments, a profile of the user (e.g., as stored and/or displayed by the server 102) may include a link to the charity, or a means to donate money to the charity. In this way, another user who identifies the original user and looks up the original user may have the opportunity to donate to the charity identified by the first user. The other user may have the opportunity to make the donation straight from the profile of the first user.

In some embodiments, a user may select apparel (e.g., for purchase). In selecting apparel, the user may select or customize one or more aspects of the apparel. For example, the user may select a size, cut, gender, measurement, sleeve length, trouser length, waist size, shoe size, collar style, collar measurement, inseam measurement, and so on. In some embodiments, a user may select a color, thread count, fabric, number of buttons, gloss, stain resistance, and so on. In some embodiments, a user may select whether a male or a female version of an article is desired. In some embodiments, a user may select a logo, brand name, or image to be featured on the apparel, where such selection is independent from the visual identifier itself.

In an exemplary situation, suppose a second user remembers seeing a visual identifier worn by a first user, but can only remember 2 out of the 3 alphanumeric characters. This leaves open, for example, 36 possibilities for what the forgotten character might be (i.e., A-Z, 0-9). Therefore, in some embodiments, the server 102 may go through a process whereby the second user is shown 36 photographs of other users, and asked if they recognize the first user from any of the photographs.

In various embodiments, when a second user enters a characteristic of a visual identifier, then the server may show the second user information about a plurality of other users to whose visual identifiers the characteristic applies (e.g., the server may show the second user information about all other users to whose visual identifiers the characteristic applies). As will be appreciated, the more characteristics that the second user enters, the more the server can narrow down the possibilities of other users to whose visual identifiers such characteristics apply. In various embodiments, for each characteristic entered by the second user, the server will reduce the number of possible other users presented to the second user. For example, the server will reduce the number of possible other users to only those to whom all characteristics entered by the second user apply. Eventually, if the second user enters a fully descriptive set of characteristics from a visual identifier worn by a first user, then the server may narrow down the number of other people presented to the second user to one, i.e., to the first user.

In some embodiments, the second user may not be able to recall every characteristic of a visual identifier. But the second user may be able to enter enough characteristics so as to narrow down the field of other users, and then the second user may be able to find the first user based on the pictures of users presented to the second user by the server.

In some embodiments, this same process may be used to allow for the assignment of the same visual identifier to multiple different users. Another user, wishing to contact one of the users to whom the same visual identifier was assigned, could narrow down the universe of possible users by first describing the visual identifier, and subsequently by uniquely identifying the specific user he saw by looking at pictures of all the users with the described visual identifier.

In various embodiments, the server may provide logs, reports, or other metrics about use of the system, about contacts made, about visual identifiers seen, and so on. A server may log how many times a particular visual identifier was seen. A server may log how many times a particular user was contacted. A server may log how many times other users attempted to contact a given user. A server may log the number of times that a visual identifier containing a particular image (e.g., a particular logo) was seen or entered into the server's Website (e.g., by a user wishing to find another user). A server may log the number of times a given user tried to make contact with any other user. A server may log the number of visual identifiers issued. A server may log the number of visual identifiers issued that incorporate a particular image. A server may log the number of items of apparel sold. A server may log the number of items of apparel sold containing a particular image or a particular visual identifier. As will be appreciated, a server or other entity may log or track any information, including information about any communication or transaction that occurs using or related to the server.

In some embodiments, the server may provide certain tracked data to a marketer, third party business, or other entity. For example, a visual identifier issued by the server may incorporate the logo of the marketer, and the marketer may be interested to see how many times its logo has been issued, sold on apparel, seen, or otherwise employed. In some embodiments, the server may sell reports or other data to a marketer or other third party. In some embodiments, the server may charge a marketer or other third party based on gathered data. For example, the server may charge a marketer every time a visual identifier incorporating the marketer's logo is reported by one user as being worn by another user.

In various embodiments, a user may be charged for use of the system. A user may be charged a registration fee, a periodic fee, a fee based on the amount of information or nature of information shown in the user's profile, or based on any other factor.

In some embodiments, a first user is charged based on the number of times another user submits to the server characteristics identifying the visual identifier of the first user. For example, every time another user reports seeing the patch worn by the first user, the first user is charged five cents. In some embodiments, a first user is charged for every time the first user accepts a request for contact from a second user. In some embodiments, a user is charged every time he initiates contact with another user. As will be appreciated, users can be charged in various other ways and in various amounts, according to various embodiments.

In some embodiments, a user may be charged for the use of a particular visual identifier, or component of a visual identifier. For example, if a user wishes to use a given image in his visual identifier, the user may be required to pay a $10 fee.

In some embodiments, a marketer or other third party may be charged for the privilege of having its brand, logo, or other mark used by the system. A marketer may be charged based on the number of people that use the logo (e.g., $1 per person), based on the amount of time its logo is used (e.g., $1 per person per year), based on the number of times a connection is made between users based on a visual identifier with the marketer's logo (e.g., $5 per connection), based on the number of items (e.g., apparel) sold with its logo (e.g., $0.10 per item), based on the number of times its logo is viewed on a Web page of the server, or based on any other factor.

In some embodiments, a marketer may be paid for the use of its logo. For example, the server, or an entity associated with the server, may pay the marketer based on the number and types of uses of its logo, e.g., for some of the uses described above.

In various embodiments, a second user might see a first user out in public and wish to make contact with the first user. The second user may visit the Web site of the server 102, and may enter one or more characteristics about the visual identifier worn or featured by the first user (e.g., color, image, code). The second user may enter one or more additional characteristics, such as the gender or hair color of the first user, or some other characteristic or contextual element. In some embodiments, the second user may enter a location where the second user saw the first user. The location may be entered in any suitable form, or to any suitable degree of precision, in various embodiments. For instance, the location may be entered as a country, state, city, region, province, zone, county, town, borough, municipality, zip code, street, address, block, and/or in any other form. A location may also be reported as a proximity to a landmark or other well-known location, such as an airport, national park, etc. The server may have on record an indication of the first user's area of residence or habitation. As such, the location at which the second user saw the first user can be used as a piece of information to identify the first user. For example, the first user may possess the same visual identifier as does a third user, but may live in a different location. As such, a means to distinguish the first and third users may be by location in which they were seen.

In some embodiments, after the second user has reported seeing the visual identifier of the first user at a given location, the server may ask the first user whether he was in fact at that location. In some embodiments, the server may ask all users with the reported visual identifier whether they were at that location. The server may, for example, receive from the second user a date and/or time at which the second user saw the visual identifier. The server may then ask all users with that visual identifier whether they were at the specified location at the specified time. Only those that answer affirmatively may be put in contact with the second user (or given the opportunity to be contacted by the second user).

In various embodiments, a person may be prevented or discouraged from wearing or displaying a visual identifier that is made to appear like a visual identifier that has not been issued or approved for use by the first person. E.g., a person may be discouraged from altering a visual identifier to appear like another visual identifier. Such alterations could result, for example, in the wrong person being contacted.

In various embodiments, the server may restrict access to the system 100, and/or to various visual identifiers or components of visual identifiers. For example, the server may restrict access to people under a certain age. In various embodiments, a marketer logo may be featured in a visual identifier. The marketer may wish to choose what type of people would be good ambassadors of its brand. For example, if the marketer's target audience is a particular demographic (e.g., age range, gender), then the marketer may desire that people of that same demographic be the only ones that can exhibit the visual identifier.

In some embodiments, a visual identifier, or a component thereof, may be introduced by a user. The user may wish to restrict the use of the visual identifier, or component thereof, only to certain designated friends.

In some embodiments, a visual identifier may represent an organization, such as a fraternity, or graduates of a particular school. In such cases, use of the visual identifier may be restricted to only those who e.g., belong to the organization, or only to those who, e.g., are graduates of the particular school.

As will be appreciated, access to the system and/or to a particular visual identifier may be restricted in various ways, and such restrictions may be accomplished in various ways. As will be appreciated access to the entire system or to certain parts, features, or functionalities of the system may be restricted, in various embodiments.

In various embodiments, when a user attempts to create a visual identifier, the server may validate that the identifier has not already been taken. For example, if a user chooses a particular combination of image, color, and code, the server may validate that the visual identifier consisting of that combination has not already been taken. If it has been taken, then the user may be asked to choose another visual identifier.

In some embodiments, a visual identifier may serve as a link to a financial account, or may be used as a charge account. For example, a user might point to his tattoo, which features a unique visual identifier, and tell a merchant to charge a purchase to the account associated with the visual identifier. The merchant may later log onto the server, report the pertinent information about the visual identifier (e.g., color, image, and code), and indicate the amount of the transaction. The server may thereupon effect the transition of money from the user to the merchant (e.g., via one or more intermediaries).

In various embodiments, distributors may go through a licensing or certification process. A distributor may be required to prove or demonstrate its ability to render a visual identifier accurately, timely, with good quality, in a safe manner, and/or in any other fashion. For example, a clothing manufacturer might be required to demonstrate an ability to print, on an article of clothing, a quality custom visual identifier within 24 hours of being provided the visual identifier, and of shipping the article within the same time period. In some embodiments, a tattoo parlor may be certified as to the safety of its practices and quality of its work, before being permitted to apply visual identifiers to people.

In various embodiments, a visual identifier may include: a logo, a trademark, a service mark, a mascot, a seal, an acronym, the letters designating a fraternity (e.g., Greek letters), a slogan, a catch phrase, or any other visual indication, or any other indication.

### Embodiments

The following are embodiments, not claims:

L. An apparatus comprising: a processor; and a storage device in communication with the processor, the storage device storing instructions configured to direct the processor to perform a method, the method comprising:
selecting a first set of descriptors from a first category;
selecting a second set of descriptors from a second category, in which the second and first categories are mutually exclusive;
associating both the first and second sets of descriptors with a resource;
generating a visual identifier such that each of the first set of descriptors and each of the second set of descriptors applies to the visual identifier;
making the visual identifier available for public display;
receiving an indication of a third set of descriptors from a user;
determining that the third set of descriptors matches the union of the first and second sets of descriptors; and
providing, based on the determination, access to the resource for the user.

L.1 The apparatus of embodiment L in which the first category consists of alphanumeric characters.

L.1.1 The apparatus of embodiment L.1 in which the second category consists of colors.

L.1.2 The apparatus of embodiment L.1 in which the second category consists of descriptors of images.

L.1.3. The apparatus of claim L.1.2 in which the resource is a web page.

In various embodiments, a visual identifier can include symbols (e.g., letters), but at least one descriptor of the visual identifier is not the literal meaning of the symbols. For example, at least one descriptor might be a color, or font, but not the literal symbol description of “az3”.

K. An apparatus comprising: a processor; and a storage device in communication with the processor, the storage device storing instructions configured to direct the processor to perform a method, the method comprising:
associating a first set of descriptors with a resource;
generating a visual identifier that comprises one or more symbols, wherein the visual identifier is generated such that each of the first set of descriptors applies to the visual identifier, and at least one of the first set of descriptors is a descriptor of an aspect of the visual identifier other than a literal meaning of one of the symbols;
making the visual identifier available for public display;
receiving an indication of a second set of descriptors from a user;
determining that the second set of descriptors matches the first set of descriptors; and
providing, based on the determination, access to the resource for the user.

K.4 The apparatus of embodiment K in which each of the one or more symbols is an alphanumeric character, and in which at least one of the first set of descriptors describes an aspect of the visual identifier other than a literal recitation of one of the alphanumeric characters.

In some cases, though a visual identifier may depict only symbols, a descriptor of the visual identifier may nevertheless describe the manner in which such symbols are depicted (e.g., shown in red, e.g., shown in large font), rather than the symbols themselves. In various embodiments there is at least one descriptor of the visual identifier that describes something other than the one or more symbols depicted.

K.4.1 The apparatus of embodiment K in which the visual identifier comprises only the one or more symbols.

K.1 The apparatus of embodiment K in which the set of descriptors includes a descriptor of a color.

K.2 The apparatus of embodiment K in which the set of descriptors includes a descriptor of a font.

In some embodiments, a descriptor can say whether certain letters were capitalized or not.

K.3 The apparatus of embodiment K, in which the set of descriptors includes a descriptor of a capitalization scheme.

In some embodiments, a user may forget some characteristic (e.g., a characteristic of a visual identifier). Thus, in some embodiments, the server shows to the user all pictures of people associated with the characteristics the user does remember, and then the user can pick the person from the pictures.

M. An apparatus comprising: a processor; and a storage device in communication with the processor, the storage device storing instructions configured to direct the processor to perform a method, the method comprising:
associating a first set of characteristics with a first user;
associating a second set of characteristics with a second user;
obtaining a first picture of the first user;
obtaining a first picture of the second user;
generating a first visual identifier that exhibits each of the first set of characteristics;
generating a second visual identifier that exhibits each of the second set of characteristics;
making the first visual identifier available for public display by the first user;
making the second visual identifier available for public display by the second user;
receiving an indication of a third set of characteristics from a third user;
determining that the third set of characteristics is a subset of the first set of characteristics;
determining that the third set of characteristics is a subset of the second set of characteristics;
providing, based on the determinations, both the first picture and the second picture for display to the third user;
receiving from the third user a selection of the first picture;
facilitating, based on the selection of the first picture, communication between the third user and the first user.

In some embodiments, the aforementioned apparatus may include a processor performing the steps of associating a resource with the first user, and ultimately providing access to this resource by the third user.

F. An apparatus comprising: a processor; and a storage device in communication with the processor, the storage device storing instructions configured to direct the processor to perform a method, the method comprising:
associating a first set of characteristics with a resource;
generating a visual identifier that exhibits each of the first set of characteristics, wherein less than the full first set of characteristics are exhibited as alphanumeric codes;
making the visual identifier available for public display;
receiving an indication of a second set of characteristics from a user;
determining that the second set of characteristics matches the first set of characteristics; and
providing, based on the determination, access to the resource for the user.

In some embodiments, the generating step may alternatively include one of:
(a) generating a visual identifier that exhibits each of the first set of characteristics, wherein at least one of the first set of characteristics is exhibited in analog form;
(b) generating a visual identifier that exhibits each of the first set of characteristics, wherein at least one of the first set of characteristics is exhibited without being described;
(c) generating a visual identifier that exhibits each of the first set of characteristics, wherein at least one of the first set of characteristics is exhibited in non-symbolic form;
(d) generating a visual identifier that exhibits each of the first set of characteristics, wherein at least one of the first set of characteristics is exhibited in human-recognizable form;

F.6 The apparatus of embodiment F, in which generating a visual identifier includes generating a visual identifier that exhibits each of the first set of characteristics, wherein none of the set of the first set of characteristics are exhibited as alphanumeric codes.

F.1 The apparatus of embodiment F, in which the first set of characteristics includes a color.

F.2 The apparatus of embodiment F, in which the visual identifier is an image.

F.3 The apparatus of embodiment F, in which the resource is one of: (a) an email address; (b) a uniform resource locator; (c) a Web page; (d) a Web profile; (e) a home page; (f) a data repository; (g) an account; (h) a program; (i) a game; (j) a music file; (k) a video; and (l) an image.

In some embodiments a “match” need not be total or exact, but can include a partial alignment of sets of characteristics.

F.4 The apparatus of embodiment F, in which determining that the second set of characteristics matches the first set of characteristics includes determining that each of a first subset of the first set of characteristics is identical to one of the second set of characteristics.

In some embodiments, a “match” must be total.

F.5 The apparatus of embodiment F, in which determining that the second set of characteristics matches the first set of characteristics includes determining that the first set of characteristics is identical to the second set of characteristics.

N. An apparatus comprising: a processor; and a storage device in communication with the processor, the storage device storing instructions configured to direct the processor to perform a method, the method comprising:
associating a first set of characteristics with a resource;
generating a visual identifier that exhibits each of a first subset of the first set of characteristics;
making the visual identifier available for public display by a first user with a second subset of the first set of characteristics, in which the second subset is not a subset of the first subset;
receiving an indication of a second set of characteristics from a second user;
determining that the second set of characteristics matches the first set of characteristics; and
providing, based on the determination, access to the resource for the second user.

N.1 The apparatus of embodiment N in which the union of the first subset and the second subset makes the first set.

G. An apparatus comprising: a processor; and a storage device in communication with the processor, the storage device storing instructions configured to direct the processor to perform a method, the method comprising:
associating a first set of descriptors with a resource;
generating a visual identifier to which each of the first set of descriptors applies;
making the visual identifier available for public display;
receiving an indication of a second set of descriptors from a user;
determining that the second set of descriptors matches the first set of descriptors; and
providing, based on the determination, access to the resource for the user.

G.1 The apparatus of embodiment G in which less than the full set of descriptors are alphanumeric codes.

In various embodiments, the server 102 may ensure that a given patch links to only one resource. In other words, two images might inadvertently be given overlapping sets of descriptors, such that both could link to the same resource even if this was not the intention.

H. An apparatus comprising: a processor; and a storage device in communication with the processor, the storage device storing instructions configured to direct the processor to perform a method, the method comprising:
associating each of a plurality of sets of descriptors with a respective resource;
determining a first set of descriptors not among the plurality of sets of descriptors;
generating a visual identifier to which each of the first set of descriptors applies;
determining, for each of the plurality of sets of descriptors, that at least one descriptor does not apply to the visual identifier;
making the visual identifier available for public display;
receiving an indication of a second set of descriptors from a user;
determining that the second set of descriptors matches the first set of descriptors; and
providing, based on the determination, access to the resource for the user.

In various embodiments, the visual identifier itself doesn't tell the full story. Some of the characteristics come from the “context”, which might include the gender of the person wearing the visual identifier.

I. An apparatus comprising: a processor; and a storage device in communication with the processor, the storage device storing instructions configured to direct the processor to perform a method, the method comprising:
associating a first set of characteristics with a resource;
generating a visual identifier that exhibits a first subset of the first set of characteristics;
making the visual identifier available for public display in a context that exhibits a second subset of the first set of characteristics, such that the union of the first subset and the second subset together make the full first set of characteristics;
receiving an indication of a second set of characteristics from a first user;
determining that the second set of characteristics matches the first set of characteristics; and
providing, based on the determination, access to the resource for the first user.

In some embodiments some of the characteristics could be characteristics of the wearer himself, not just of the visual identifier.

I.1 The apparatus of embodiment I in which making the visual identifier available for public display includes providing to a second user an article of apparel to wear, in which the article of apparel incorporates the visual identifier, and in which each of the second subset of the first set of characteristics are characteristics of the second user.

In some embodiments the characteristic could be a gender.

I.1.2 The apparatus of embodiment I.1, in which one of the second subset of the first set of characteristics is a gender of the second user.

I.3 The apparatus of embodiment I, in which determining that the second set of characteristics matches the first set of characteristics includes determining that each of a first subset of the first set of characteristics is identical to one of the second set of characteristics.

I.4 The apparatus of embodiment I, in which determining that the second set of characteristics matches the first set of characteristics includes determining that the first set of characteristics is identical to the second set of characteristics.

I.5 The apparatus of embodiment I, wherein less than the full first subset of characteristics are exhibited as alphanumeric codes.

In some embodiments, a user may be identified by indicia in combination with a user characteristic. Indicia may include images, codes, symbols, or any combination thereof. A user characteristic may include any physical characteristic, such as eye color, hair color, gender, height, and so on.

D. An apparatus comprising: a processor; and a storage device in communication with the processor, the storage device storing instructions configured to direct the processor to perform a method, the method comprising:
associating a first user with first indicia;
associating the first user with a first characteristic;
generating a resource for the first user;
generating a first visual identifier based on the first indicia;
issuing instructions for the provision to the first user of the first visual identifier;
receiving from a second user an indication of second indicia;
receiving from the second user an indication of a second characteristic;
determining that the second indicia match the first indicia, and that the second characteristic matches the first characteristic; and
providing, based on the determination, an indication of the resource to the second user.

D.1 The apparatus of embodiment D in which the first indicia includes at least one of: (a) an alphanumeric code; (b) an image; and (c) a color.

D.2 The apparatus of embodiment D in which the first characteristic is one of: (a) gender; (b) age; (c) eye color; and (d) hair color.

D.3 The apparatus of embodiment D in which determining that the second indicia match the first indicia includes determining that some of the second indicia are the same as some of the first indicia.

D.4 The apparatus of embodiment D in which determining that the second indicia match the first indicia includes determining that all of the second indicia are the same as all of the first indicia.

J. An apparatus comprising: a processor; and a storage device in communication with the processor, the storage device storing instructions configured to direct the processor to perform a method, the method comprising:
generating a plurality of combinations of alphanumeric identifiers and images;
issuing instructions for the incorporation of each of the plurality of combinations into respective articles of apparel;
receiving from a first user a first alphanumeric identifier;
receiving from the first user a selection of a first image;
receiving from the first user proof that the first user has obtained an article of apparel incorporating a first of the plurality of combinations comprising the first alphanumeric identifier and the first image;
receiving identifying information from the first user;
generating a resource for the first user, in which the resource is generated based on the identifying information;
storing, in association with one another, indications of the first alphanumeric identifier, the first image, and the identifying information;
generating a first visual identifier based on the first alphanumeric identifier, and the first image;
receiving from a second user a second alphanumeric identifier;
receiving from the second user an indication of a second image;
determining that the second alphanumeric identifier matches the first alphanumeric identifier, and the second image matches the first image; and
providing, based on the determination, an indication of the resource to the second user.

In various embodiments, visual identifiers may be incorporated beforehand (e.g., before any user has signed up for such visual identifiers) into articles of apparel. Such articles of apparel may be sold through one or more retailers. When a user purchases one such article of apparel, the user may register the visual identifier. The user may thereby, for example, cause the visual identifier to be associated with his identity.

E. An apparatus comprising: a processor; and a storage device in communication with the processor, the storage device storing instructions configured to direct the processor to perform a method, the method comprising:
generating a plurality of combinations of alphanumeric identifiers, images, and colors;
issuing instructions for the incorporation of each of the plurality of combinations into respective articles of apparel;
receiving from a first user proof that the first user has obtained an article of apparel incorporating a first of the plurality of combinations comprising a first alphanumeric identifier, a first image, and a first color;
receiving identifying information from the first user;
generating a resource for the first user, in which the resource is generated based on the identifying information;
storing, in association with one another, indications of the first alphanumeric identifier, the first image, the first color, and the identifying information;
generating a first visual identifier based on the first alphanumeric identifier, the first image, and the first color;
receiving from a second user a second alphanumeric identifier;
receiving from the second user an indication of a second image;
receiving from the second user an indication of a second color;
determining that the second alphanumeric identifier matches the first alphanumeric identifier, the second image matches the first image, and the second color matches the first color; and
providing, based on the determination, an indication of the resource to the second user.

E.4 The apparatus of embodiment E, the method further comprising:
receiving from the first user an indication of a first alphanumeric identifier;
receiving from the first user an indication of a first image; and
receiving from the first user an indication of a first color.

In some embodiments, before a user can register a particular visual identifier, he must provide proof that he has obtained an article of apparel incorporating the visual identifier. In some embodiments, each visual identifier is associated with a registration code. The registration code may be an alphanumeric sequence of characters, or any other form of code, as will be appreciated. The registration code may be included in the article of apparel. For example, the registration code may appear on a label attached to the article of apparel. When the user purchases the article of apparel, the user may later submit the registration code as well as an indication of the visual identifier, in order to register the visual identifier. In some embodiments, the user may submit the registration code alone. The system may be capable of tying the registration code to the visual identifier via, e.g., a database linking registration codes to visual identifiers.

E.1 The apparatus of embodiment E, in which the method further comprises:
associating with each combination a registration code,
in which receiving proof includes receiving from the first user a first registration code that is associated with the first combination.

E.1.1 The apparatus of embodiment E.1, in which each registration code is a sequence of alphanumeric characters.

E.2 The apparatus of embodiment E, in which issuing instructions includes:
issuing instructions for the incorporation of each of the plurality of combinations into respective articles of apparel sold at a first retailer,
in which receiving proof includes receiving from the first user a receipt from the first retailer that the first user has obtained an article of apparel incorporating a first of the plurality of combinations comprising the first alphanumeric identifier, the first image, and the first color.

E.3 The apparatus of embodiment E, in which the method further comprises storing an indication that the first combination is now registered by the first user and is no longer available for registration to other users.

A′. An apparatus comprising: a processor; and a storage device in communication with the processor, the storage device storing instructions configured to direct the processor to perform a method, the method comprising:
associating a first user with a first alphanumeric identifier;
associating the first user with a first image;
receiving identifying information from the first user;
generating a resource for the first user, in which the resource is an email address comprising a character string that combines the first alphanumeric identifier and the name of the first image;
generating a first visual identifier based on the first alphanumeric identifier, and the first image;
issuing instructions for the provision to the first user of the first visual identifier;
receiving from a second user an indication of the resource and a message; and
transmitting the message to the first user.

A. An apparatus comprising: a processor; and a storage device in communication with the processor, the storage device storing instructions configured to direct the processor to perform a method, the method comprising:
associating a first user with a first alphanumeric identifier;
associating the first user with a first image;
associating identifying information with the first user;
generating a resource for the first user, in which the resource is generated based on the identifying information;
generating a first visual identifier based on the first alphanumeric identifier, and the first image;
issuing instructions for the provision to the first user of the first visual identifier;
receiving from a second user a second alphanumeric identifier;
receiving from the second user an indication of a second image;
determining that the second alphanumeric identifier matches the first alphanumeric identifier and the second image matches the first image; and
providing, based on the determination, access to the resource to the second user.

A.19 The apparatus of embodiment A in which associating a first user with a first alphanumeric identifier includes automatically assigning to the first user the first alphanumeric identifier.

In some embodiments, before an image, code, or color is associated with a user, the user might actually make the selection of the image, code, or color.

A.18 The apparatus of embodiment A, the method further comprising:
receiving from the first user the first alphanumeric identifier; and
receiving from the first user a selection of the first image.

A.16 The apparatus of embodiment A, in which the method further comprises:
storing, in association with one another, indications of the first alphanumeric identifier, the first image, and the identifying information;

A.17 The apparatus of embodiment A, in which the method further comprises:
associating the first user with a first color;
receiving from the second user an indication of a second color; and
determining that the second color matches the first color,
in which generating a first visual identifier includes generating a first visual identifier based on the first alphanumeric identifier, the first color, and the first image;

A.17.1 The apparatus of embodiment A.17, in which the visual identifier incorporates the first image and the first alphanumeric identifier, both rendered using the first color.

In some embodiments, the second user may input additional descriptors or characteristics of the first user beyond those shown in the visual identifier. For example, the second user may input the gender of the first user. In some embodiments, the second user may input such other characteristics as height, hair color, eye color, approximate age, and so on.

A.15 The apparatus of embodiment A, in which the method further comprises:
receiving from the second user a characteristic; and
determining that the characteristic is consistent with the identifying information, in which the step of providing further includes providing, based on the determination that the characteristic is consistent with the identifying information, an indication of the resource to the second user.

A.15.1 The apparatus of embodiment A.15, in which the characteristic is at least one of: (a) a gender; (b) a hair color; and (c) an eye color.

In some embodiments, a characteristic or descriptor may include a characteristic or descriptor of what the first user is wearing, or an accessory the first user is carrying. A descriptor may include a brand name. An accessory may include a purse, pouch, or handbag, for example.

A.15.2 The apparatus of embodiment A.15, in which the characteristic is at least one of: (a) a type of clothing; (b) a brand of clothing; (c) a brand identifier; and (d) type of accessory.

In various embodiments, once the second user receives an indication of the second resource, the second user can use it to send an email to the first user.

A.14 The apparatus of embodiment A, in which the identifying information includes a first email address of the first user, and in which the resource is the first email address.

A.14.1 The apparatus of claim A.14, in which the step of providing access to the first email address includes receiving from the second user an electronic mail directed to an email address that incorporates the first alphanumeric identifier, the name of the first color, and a descriptor of the first image; and retransmitting the electronic mail to the email address of the first user.

In various embodiments, once the second user receives an indication of the second resource, the second user can use it access a profile of the first user.

A.15 The apparatus of embodiment A, in which the resource is a uniform resource locator, the method further comprising:
receiving from the second user a selection of the resource; and
presenting to the second user, via a web page, a subset of the identifying information.

In some embodiments, the first user may have an opportunity to receive the first visual identifier in a variety of forms. For example, the user may have the opportunity to receive the first visual identifier printed on, or otherwise incorporated into an article of clothing. The user may peruse various clothing options and may select one and may purchase one.

A.13 The apparatus of embodiment A, in which the method further comprises:
receiving from the user a selection of an article of clothing, in which issuing instructions includes issuing instructions for the provision of the selected article of clothing to the user with the visual identifier incorporated into the article of clothing.

A.13.1 The apparatus of embodiment A.13, in which the method further comprises:
receiving payment from the user for the article of clothing.

In various embodiments, the system may issue instructions to a third party, such as to a clothing manufacturer.

A.14 The apparatus of embodiment A in which issuing instructions includes instructing a third party to provide the first user with the first visual identifier.

A.14.1 The apparatus of embodiment A.14, in which issuing instructions includes instructing a clothing manufacturer to provide the first user with an article of clothing incorporating the first visual identifier.

In some embodiments, the first user can be provided the first visual identifier in electronic form. For example, in some embodiments, the user can email the first visual identifier.

A.12 The apparatus of embodiment A, in which issuing instructions includes issuing instructions for the provision to the first user of the visual identifier in electronic form.

A.12.1 The apparatus of embodiment A.12, in which issuing instructions includes issuing instructions for the first visual identifier to be emailed to the first user.

A.11 The apparatus of embodiment A, in which the visual identifier incorporates the first image and the first alphanumeric identifier.

A.11.1 The apparatus of embodiment A.11 in which the first alphanumeric code appears beneath the first image.

In various embodiments, the user may be provided with a visual identifier incorporated into the article of clothing.

A.10 The apparatus of embodiment A, in which issuing instructions include issuing instructions for the provision to the first user of an article of clothing with the visual identifier incorporated into the article of clothing.

In various embodiments, a visual identifier may be printed on an article of clothing.

A.10.1 The apparatus of embodiment A.10, in which the article of clothing includes the visual identifier printed on the article of clothing.

In various embodiments, a visual identifier may be woven into an article of clothing.

A.10.2 The apparatus of embodiment A.10, in which the article of clothing includes the visual identifier woven into the article of clothing.

A.9 The apparatus of embodiment A, in which receiving identifying information from the first user includes receiving at least one of: (a) a name; (b) an address; (c) an email address; (d) a uniform resource locator; (e) a phone number; (f) an alias; and (g) a postal address.

A.1 The apparatus of embodiment A, in which the first alphanumeric identifier comprises three letters.

A.2 The apparatus of embodiment A, in which the resource is an email address.

A.2.1 The apparatus of embodiment A, in which the resource is an email address that incorporates the first alphanumeric identifier.

A.2.2 The apparatus of embodiment A, in which the resource is an email address that incorporates the first alphanumeric identifier, the name of the first color, and a descriptor of the first image.

A.3 The apparatus of embodiment A, in which the resource is a uniform resource locator.

A.4 The apparatus of embodiment A, in which the resource is a web page.

A.5 The apparatus of embodiment A, in which the resource is a profile page.

In some embodiments, a user may select from among existing images. For example, the user may select by double clicking on one image out of a number of images presented to the user on a web page.

A.6 The apparatus of embodiment A, in which receiving from the first user a selection of a first image includes:
presenting to the first user a plurality of image choices; and
receiving from the first user a selection of one of the image choices.

In some embodiments, a user may be able to upload his own image to use.

A.7 The apparatus of embodiment A, in which receiving from the first user a selection of a first image includes receiving a first image that has been provided by the first user.

In some embodiments, when a user uploads his own image, the image may be stored. Meta-data about the image may be generated, so that the image can later be retrieved based on the meta-data. For example, the user may be asked to provide some words that are descriptive of the image. In some embodiments, descriptors for the image may be generated by an employee, or by any other party. In some embodiments, descriptors for the image may be generated automatically, such as through image recognition software. Various other methods of generating descriptors or meta-data may be used, as will be appreciated.

A.7.1 The apparatus of embodiment A.7, in which the method further comprises:
determining a descriptor of the first image; and
storing the descriptor in association with the first image.

In various embodiments, once user information is received, the user may be validated. Validation may include determining whether the user will be allowed to participate in the system, to have an account with the system, to receive an identifier from the system, and so on. In some embodiments, a validation step may include determining whether the user is at least 18 years of age.

A.9 The apparatus of embodiment A, in which the method further comprises validating the user based on the user identifying information.

Applicants claim:

1. An apparatus comprising: a processor; and a storage device in communication with the processor, the storage device storing instructions configured to direct the processor to perform a method, the method comprising:
selecting a first set of descriptors from a first category;
selecting a second set of descriptors from a second category, in which the second and first categories are mutually exclusive;
associating both the first and second sets of descriptors with a resource;
generating a visual identifier such that each of the first set of descriptors and each of the second set of descriptors applies to the visual identifier;
making the visual identifier available for public display;
receiving an indication of a third set of descriptors from a user;
determining that the third set of descriptors matches the union of the first and second sets of descriptors; and
providing, based on the determination, access to the resource for the user.

2. The apparatus of claim 1 in which the first category consists of alphanumeric characters.

3. The apparatus of claim 2 in which the second category consists of colors.

4. The apparatus of claim 2 in which the second category consists of descriptors of images.

5. The apparatus of claim 4 in which the resource is a web page.

6. An apparatus comprising: a processor; and a storage device in communication with the processor, the storage device storing instructions configured to direct the processor to perform a method, the method comprising:
associating a first user with first indicia;
associating the first user with a first characteristic;
generating a resource for the first user;
generating a first visual identifier based on the first indicia;
issuing instructions for the provision to the first user of the first visual identifier;
receiving from a second user an indication of second indicia;
receiving from the second user an indication of a second characteristic;
determining that the second indicia match the first indicia, and that the second characteristic matches the first characteristic; and
providing, based on the determination, an indication of the resource to the second user.

7. The apparatus of claim 6 in which the first indicia includes at least one of: (a) an alphanumeric code; (b) an image; and (c) a color.

8. The apparatus of claim 6 in which the first characteristic is one of: (a) gender; (b) age; (c) eye color; and (d) hair color.

9. The apparatus of claim 6 in which determining that the second indicia match the first indicia includes determining that some of the second indicia are the same as some of the first indicia.

10. The apparatus of claim 6 in which determining that the second indicia match the first indicia includes determining that all of the second indicia are the same as all of the first indicia.

11. An apparatus comprising: a processor; and a storage device in communication with the processor, the storage device storing instructions configured to direct the processor to perform a method, the method comprising:
associating a first user with a first alphanumeric identifier;
associating the first user with a first image;
associating identifying information with the first user;
generating a resource for the first user, in which the resource is generated based on the identifying information;
generating a first visual identifier based on the first alphanumeric identifier, and the first image;
issuing instructions for the provision to the first user of the first visual identifier;
receiving from a second user a second alphanumeric identifier;
receiving from the second user an indication of a second image;
determining that the second alphanumeric identifier matches the first alphanumeric identifier and the second image matches the first image; and
providing, based on the determination, access to the resource to the second user.

12. The apparatus of claim 11, in which the method further comprises:
storing, in association with one another, indications of the first alphanumeric identifier, the first image, and the identifying information.

13. The apparatus of claim 11, in which the method further comprises:
associating the first user with a first color;
receiving from the second user an indication of a second color; and
determining that the second color matches the first color,
in which generating a first visual identifier includes generating a first visual identifier based on the first alphanumeric identifier, the first color, and the first image;

14. The apparatus of claim 13, in which the visual identifier incorporates the first image and the first alphanumeric identifier, both rendered using the first color.

15. The apparatus of claim 11, in which the method further comprises:
receiving from the second user a characteristic; and
determining that the characteristic is consistent with the identifying information, in which the step of providing further includes providing, based on the determination that the characteristic is consistent with the identifying information, an indication of the resource to the second user.

16. The apparatus of claim 11, in which the identifying information includes a first email address of the first user, and in which the resource is the first email address.

17. The apparatus of claim 16, in which the step of providing access to the first email address includes receiving from the second user an electronic mail directed to an email address that incorporates the first alphanumeric identifier, the name of the first color, and a descriptor of the first image; and retransmitting the electronic mail to the email address of the first user.

18. The apparatus of claim 11, in which the resource is a uniform resource locator, the method further comprising:
receiving from the second user a selection of the resource; and
presenting to the second user, via a web page, a subset of the identifying information.

19. The apparatus of claim 11, in which the visual identifier incorporates the first image and the first alphanumeric identifier.

20. The apparatus of claim 11, in which issuing instructions include issuing instructions for the provision to the first user of an article of clothing with the visual identifier incorporated into the article of clothing.
